(19) United States
(12) Patent Application Publication
(10) Pub. No.: US 2022/0162833 A1
(43) Pub. Date: May 26, 2022

(54) IMPLEMENT AND METHOD OF ACTUATING A DRIVE THEREOF

(71) Applicant: LIEHERR-MCCTEC ROSTOCK GMBH, Rostock (DE)

(72) Inventors: Reinhard VILBRANDT, Kritzmow (DE); Martin SEIFERT, Rostock (DE)

(21) Appl. No.: 17/456,535

(22) Filed: Nov. 24, 2021

(30) Foreign Application Priority Data
Nov. 26, 2020 (DE) 10 2020 131 331.4

(51) Int. Cl. E02F 9/20; E02F 9/22; B66C 13/48; B66C 13/42

(52) U.S. Cl. CPC E02F 9/2029; B66C 13/42; B66C 13/48; E02F 9/2203

(57) ABSTRACT

This disclosure relates to an implement, in particular crane or excavator, comprising a drive, a control unit, a measuring device and a memory. A component of the implement can be moved by means of the drive, wherein the drive can be actuated via the control unit. The measuring device can detect an actual variable relating to a movement of the driven component. In the memory, at least one characteristic curve for the actuation of the drive is stored. On the basis of a detected deviation, the control unit according to the disclosure can independently adjust the characteristic curve stored already or generate a new characteristic curve and store the same in the memory. The disclosure furthermore relates to a method of actuating a drive of such an implement.

### CROSS REFERENCE TO RELATED APPLICATION

The present application claims priority to German Patent Application No. 10 2020 131 331.4 filed on Nov. 26, 2020. The entire contents of the above-listed application is hereby incorporated by reference for all purposes.

### TECHNICAL FIELD

The present disclosure relates to an implement, in particular a crane or excavator, comprising a drive, a control unit, a measuring device and a memory, wherein the control unit is adapted to determine a control variable with reference to a characteristic curve stored in the memory and, upon detection of a deviation between a detected actual variable and a setpoint variable relating to a movement of a component driven by the drive, to adjust the characteristic curve or to generate a new characteristic curve. The present disclosure furthermore relates to a method of actuating a drive of such an implement.

### BACKGROUND

In many implements such as e.g. mobile cranes or hydraulic excavators the actuation of the hydraulic hoisting gears or other hydraulic units is effected by means of stored characteristic curves or characteristic maps. With reference to such characteristic curves or characteristic maps it is possible for example to convert a setpoint speed for a hoisting gear into a current value for the actuation of the drive or of the hydraulic pilot control of the drive of the hoisting gear, wherein e.g. non-linear profiles of the hydraulic systems are taken into account. When several characteristic curves are provided for different values of further parameters such as e.g. temperature or load, reference is made to characteristic maps or characteristic curve maps.

The characteristic curves or maps are stored in the implement and usually are set or adjusted manually in the factory, for example after a component change. Modifications of operating points of the actuated components effected between the manual adjustments, for example due to aging (e.g. increased leakage of hydraulic oil) or an exchange of components taking place on site, currently are not taken into account systematically. The manual settings of the characteristic curves frequently are carried out subjectively in different ways depending on the fitter and in general are very time-consuming.

### SUMMARY

It is therefore the object of the present disclosure to improve the actuation in such implements. In particular modifications of the operating points of actuated components are to be taken into account simply, promptly and systematically.

In accordance with the disclosure, this object is achieved by an implement. Accordingly, there is proposed an implement, in particular a lifting gear and/or crane or excavator, which comprises a drive, a control unit, a measuring device connected to the control unit, and a memory connected to the control unit. A component of the implement can be moved by means of the drive, wherein the drive can be actuated directly or indirectly via the control unit. The measuring device can detect an actual variable relating to a movement of the driven component. In the memory, at least one characteristic curve for the actuation of the drive is stored.

In accordance with the disclosure, the control unit is adapted to determine a control variable for the actuation of the drive in dependence on a setpoint variable relating to or characterizing the movement of the component. Furthermore, the control unit is designed to compare the values of the detected actual variable and setpoint variable with each other and to detect a deviation between these values. On the basis of the detected deviation, the control unit according to the disclosure can independently adjust the characteristic curve stored already or generate a new characteristic curve and store the same in the memory, in particular in parallel to the characteristic curve stored already.

Due to the comparison of the measured actual variable with the specified setpoint variable and the dynamic adjustment of a stored characteristic curve or generation of a new adjusted characteristic curve by the control unit, deviations of the characteristic values of the actuated system can be detected and evaluated promptly. As a result, modifications of the characteristic values, for example due to signs of aging, after an exchange of components or due to component tolerances, can be compensated and the actuation can be improved thereby. A manual calibration of the characteristic curves no longer is necessary or can be effected merely as a supplement. The adjustment/new generation of the characteristic curves can be carried out on command by an operator or independently and/or automatically.

The proposed adaptive system for the adaptation of the characteristic curves or maps significantly increases the quality of the actuation of the drives or units of the implement, and systematic changes or malfunctions are compensated.

Strictly speaking, the detection of the actual variable is a detection of the value of the actual variable. The same applies for the control variable, whose value is determined with reference to the characteristic curve. For reasons of simplicity, however, reference here is simply made to the actual variable, the setpoint variable and the control variable, and not to their values.

Embodiments of the disclosure can be taken from the following description.

The characteristic curve in the literal sense can be an individual characteristic curve, a part of a characteristic map or characteristic curve map comprising a plurality of individual characteristic curves, or a multidimensional characteristic map or characteristic curve map.

The drive can be a hydraulic motor or a hydraulic cylinder. The drive can be pilot-controlled, for example via an actuator or valve, or can be actuated directly. The actuation can be effected electrically, i.e. the control variable in particular is an electric variable such as e.g. a current value. The control variable furthermore can be a regulating variable, i.e. the actuation of the drive referred to here can be a regulation.

The control unit can perform the comparison between actual and setpoint variable as well as the analysis and detection of the deviation directly locally in the implement. Alternatively, it is conceivable that the control unit transmits the actual and setpoint variables to an external computer unit or cloud, in particular wirelessly, and the comparison as well as the analysis or detection of the deviations is carried out externally by the computer unit or cloud. In this case, it can be provided that the characteristic curve locally stored in the memory of the implement is adapted after a transmission of corresponding data or signals of the computer unit. Furthermore, it is imaginable that upon detection of a deviation a new characteristic curve is generated and possibly further adjusted, which initially is stored outside the implement so that the determination of the control variable furthermore is effected with reference to the locally stored characteristic curve. At a certain point in time, the newly generated characteristic curve can then be transmitted to the implement or the control unit and be loaded into the memory.

The detection and/or analysis of a deviation between actual variable and setpoint variable and/or the selection of suitable measurement data for this comparison can be effected by using a fuzzy logic and/or a self-learning or machine-learning algorithm.

In a possible embodiment it is provided that the control unit is adapted to carry out the detection of the actual variable and the comparison with the setpoint variable several times, in particular at regular time intervals, during the operating period of the implement. The actual variable can be detected several times within individual operating phases, i.e. between the respective downtimes, of the implement. Alternatively, it can be provided that the actual variable is detected at fixed times or at certain events, for example when the implement is started. Due to a continuous detection of the actual variable and a correspondingly continuous comparison with the setpoint variable, deviations can be detected and possibly be compensated reliably and promptly.

In another possible embodiment it is provided that a plurality of characteristic curves are stored in the memory. The same can form groups of characteristic maps, and it can be provided that always entire characteristic maps are adapted or newly created by the control unit. The characteristic maps in turn can likewise be grouped or clustered with reference to particular variables or parameters such as e.g. temperature, load or an operating state of the implement. The control unit is adapted to determine the control variable in dependence on the setpoint variable and at least one further variable with reference to a stored characteristic curve. The further variable can likewise be detected by means of a further measuring device and can relate to an operating parameter of the implement, a temperature and/or a load, e.g. a lifting capacity of a hoisting gear.

In another possible embodiment it is provided that the control unit is adapted to adjust a plurality of stored characteristic curves on the basis of the detected deviation between actual variable and setpoint variable and by taking account of said further variable, or to generate a plurality of new characteristic curves and store the same in the memory. This can be effected e.g. jointly as a characteristic map or sequentially, i.e. characteristic curve by characteristic curve.

In another possible embodiment it is provided that the control unit is adapted to analyze a detected deviation between actual variable and setpoint variable and automatically carry out an adjustment of a stored characteristic curve or a generation and storage of a new characteristic curve. The adaptive adjustment of the characteristic curve(s) hence is effected independently and automatically by the control unit without a manual intervention being necessary. However, it can be provided in addition that a measurement, a comparison between actual and setpoint variable and/or the adjustment/new generation of the characteristic curve(s) can be carried out at the command of an operator. The latter can be carried out for example directly after an exchange or repair of components in order to directly initiate an adjustment of the characteristic curve(s).

In another possible embodiment it is provided that by means of the measuring device a plurality of measurement values of the actual variable can be detected at different times during the operating period of the implement, wherein the control unit is adapted to select one or more of these measurement values from the detected measurement values of the actual variable for the subsequent comparison with the setpoint variable. For this purpose, suitable filters and/or algorithms can be provided. It is thereby ensured that for the adaptive adjustment of the characteristic curve(s) only the meaningful and mathematically usable measurement values or cycles of the actual variable are employed.

In another possible embodiment it is provided that the control unit is adapted to generate a new characteristic curve and store it in the memory on the basis of a detected deviation between actual variable and setpoint variable, wherein the control variable furthermore is determined with reference to an old characteristic curve. The at least one “active” characteristic curve, which is employed for determining the control variable, hence is not adjusted directly, but initially (at least) one “inactive” characteristic curve is generated in parallel and possibly adjusted continuously, without this influencing the old, active characteristic curve or the current actuation.

The omission of a direct feedback, in which the active characteristic curve is adjusted directly and also employed directly for the actuation, can increase the robustness of the system. For example, minor fluctuations of the actual variable have no direct impact on the actuation, but initially data can be collected over a certain period or the adjustments of the characteristic curve(s) can be carried out and e.g. averaged over an extended period.

In another possible embodiment it is provided that the control unit is adapted to dynamically adjust the new characteristic curve upon detection of another deviation between newly detected actual variable and setpoint variable and/or to generate another new characteristic curve and store it in the memory, wherein the control variable furthermore is determined with reference to an old characteristic curve. Hence, in parallel to the old, still active characteristic curve a new characteristic curve is generated, which upon continued detection of deviations between actual and setpoint variable furthermore is adjusted and optimized. Alternatively, a new inactive characteristic curve can always be generated for each further detected deviation. The active characteristic curve is not influenced and a direct feedback of the adaptive system to the actuation is thereby avoided.

In another possible embodiment it is provided that the control unit is adapted to switch or change the determination of the control variable with reference to an old characteristic curve to a determination of the control variable with reference to a newly generated characteristic curve. The change may be effected upon exceedance of a limit value for a deviation between actual variable and setpoint variable and/or between old and newly generated characteristic curve and/or upon expiration of a defined time period and/or when a limit value for another detectable variable is exceeded or fallen short of.

The old characteristic curve hence initially remains active and is employed for the determination of the control variable, while one or more inactive characteristic curves are generated in parallel in dependence on the detected deviations, and possibly are dynamically adjusted and optimized. Switching the determination of the control variable to the new, adjusted characteristic curves is effected at a fixed time and with reference to the aforementioned criteria.

In another possible embodiment it is provided that the control unit is adapted to carry out the change from an old to a new characteristic curve automatically and in particular outside the operation of the implement. The switch hence is effected in particular during the downtime of the implement. This will not suddenly change the actuation behavior of the implement during the operation.

In another possible embodiment it is provided that in a calibration mode the control unit is adapted to generate at least one new characteristic curve and store it in the memory by the targeted actuation of the drive and the sequential detection of a plurality of values of the actual variable during the movement of the component. Hence, in the calibration mode test runs are carried out specifically and measurement data of the actual variable are detected in order to carry out an adjustment of the characteristic curve(s). For example, this can be effected specifically after an exchange or a maintenance or repair of a component. The calibration mode can be activatable manually, i.e. by the operator, and/or automatically by the control unit with reference to defined criteria.

In another possible embodiment it is provided that the control unit is adapted to additionally take account of operating information stored in a memory and relating to the implement upon detection of a deviation between actual variable and setpoint variable and/or upon analysis of a detected deviation. The operating information can relate to an exchange, a repair, a period of use or aging or wear of at least one component (which includes in particular also drives, actuators, etc.) of the implement. For example, aging-related increased leakage of components (e.g. valves, hydraulic pumps or hydraulic motors) of a hydraulic system can be taken into account.

In another possible embodiment it is provided that the drive is a hydraulic drive which in particular can be pilot-controlled via a hydraulic actuator. The control variable can relate to a current value for the actuation of the drive or actuator. The setpoint variable or actual variable furthermore can relate to a speed of the movement of the driven component, i.e. actual speed and setpoint speed are compared in the comparison made by the control unit. The actuator can be a hydraulic valve.

Of course, the preceding explanations also apply for embodiments in which a plurality of drives can be actuated and correspondingly at least one characteristic curve is provided for each of the drives. In doing so, actual values are detected for each of the actuated components and a comparison with corresponding setpoint variables is carried out in each case.

The setpoint variable can be specifiable by an operator input of the operator of the implement. It is likewise imaginable that the setpoint variable is stored in a memory or table and/or is determined or calculated itself, for example on the basis of an operator input. By way of example, reference is made here to the case where the operator of a crane triggers lifting of a load by an operator input, wherein the hoisting speed is determined by the control unit with reference to stored tables and further operating parameters such as e.g. the lifting capacity, the crane configuration or the like.

The value of the setpoint variable need not remain constant during the entire process of movement of the actuated component, but possibly can change (e.g. in the case of an automatically slowed down deposition of a load) so that a continuous detection of the actual variable during the movement can be required. For the comparison with the setpoint variable, however, a value representing the entire process of movement, for example a maximum, minimum or average value, can be employed. For example, the setpoint variable and actual variable can each refer to a maximum speed.

The present disclosure furthermore relates to a method of actuating a drive of an implement according to the disclosure, comprising the following steps:

determining the control variable in dependence on the setpoint variable with reference to a characteristic curve stored in the memory by means of the control unit, wherein the setpoint variable can be specified by an operator input,

actuating the drive by means of the control unit on the basis of the control variable, in order to move the actuated component,

detecting the actual variable by means of the measuring device,

comparing actual variable and setpoint variable by means of the control unit,

detecting a deviation between actual variable and setpoint variable by means of the control unit, wherein this can be done by using special filters and/or algorithms for selecting suitable measurement data, and

adjusting the stored characteristic curve or generating and storing a new characteristic curve on the basis of the detected deviation by means of the control unit.

Quite obviously, the same properties are obtained as for the implement of the disclosure, which is why a repetitive description will be omitted at this point. The possible embodiments described with respect to the implement analogously apply for the method of the disclosure.

In a possible embodiment of the method it is provided that the actual variable is detected and compared with the setpoint variable several times in a row during the operating period of the implement, wherein during the operation an old stored characteristic curve is dynamically adjusted and/or a new characteristic curve is generated and the same is adjusted. In some embodiments, the control variable furthermore is determined with reference to an old stored characteristic curve, until a limit value for a deviation between actual variable and setpoint variable and/or between an old stored characteristic curve and a newly generated characteristic curve is exceeded, until a defined time period expires and/or until a limit value for a further detectable variable is exceeded or fallen short of, whereupon from this time the control variable is determined with reference to a newly generated and now activated characteristic curve.

### BRIEF DESCRIPTION OF THE FIGURES

Further features and details of the disclosure can be taken from the exemplary embodiments explained below with reference to the Figures, in which:

FIG. 1: shows a schematic representation of the method of the disclosure according to a first exemplary embodiment; and

FIG. 2: shows a schematic representation of the method of the disclosure according to a second exemplary embodiment.

### DETAILED DESCRIPTION

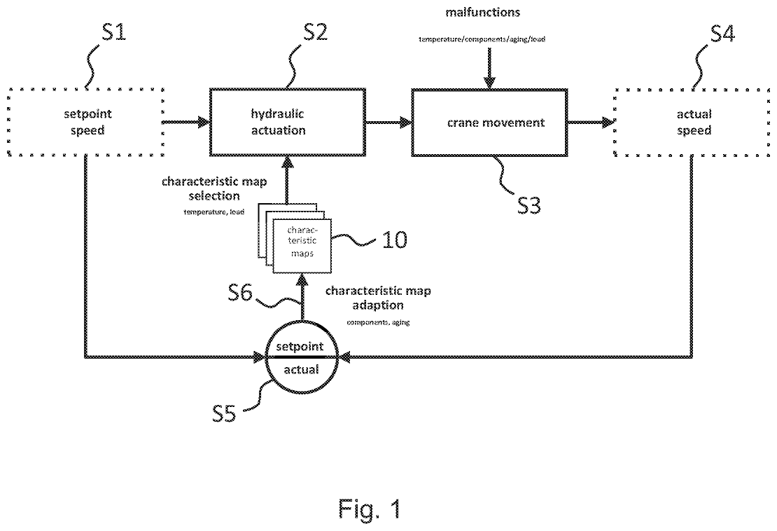

FIG. 1 schematically shows a first exemplary embodiment of the adaptive characteristic curve or characteristic map adjustment of the method according to the disclosure. In the following, the adaptive system of the disclosure will be described with reference to the example of a crane. However, the disclosure is not limited to cranes, but can be used for any kind of implement.

In the exemplary embodiment shown in FIG. 1 a crane gear or a hoisting winch for lifting a load is actuated via a hydraulic drive. The drive is pilot-controlled via a hydraulic valve, wherein the valve is electronically actuated via a control unit of the crane or a crane controller. In the memory of the implement characteristic maps 10 are stored for implementing a setpoint speed in the hoisting gear, which are used for determining a corresponding current value for actuating the drive. The characteristic maps 10 in part take account of the non-linear characteristic values of the hydraulic system (e.g. valve characteristic curves).

The characteristic maps 10 are grouped with reference to measurable variables such as temperature, load or torque. Depending on the temperature or the load to be lifted, a particular characteristic map 10 hence is used for determining the current value. This determination can be made for example by means of interpolation between discrete characteristic values stored in the characteristic map 10. As an alternative to characteristic maps, individual characteristic curves can also be stored and grouped correspondingly.

In known systems, the dependencies of the characteristic maps 10 due to aging or wear (e.g. leakage increased over time) or exchange of components are not taken into account or require a manual adjustment of the characteristic maps 10 in the factory. Possible inaccuracies typically are manually adjusted to the detriment of other operating points (e.g. slower movement, in-between loads etc.). To improve the actuation and reduce or abolish the necessity of manual adjustments, the present disclosure provides an adaptive characteristic map adjustment.

In dependence on the load to be lifted and the existing temperature (both parameters are detected by means of sensors provided for this purpose), a suitable characteristic map 10 is selected from the stored characteristic maps 10. With reference to a setpoint speed specified for example by an operator input (step S1), a current value is determined from the selected characteristic map 10 for the actuation of the hoisting gear or the valve piloting the hoisting gear, whereupon the actuation is effected by the crane controller (step S2). The actuation leads to a movement of the hoisting gear (step S3), i.e. to a lifting of the load.

By means of a measuring device, the actual speed of the hoisting gear (for example the speed of rotation of the hoisting winch or the speed of the traction means or traction cable) is measured and provided to the crane controller (step S4). The crane controller compares the measured actual speed with the specified setpoint speed (step S5). When these values differ from each other and exceed a limit value stored in the crane controller or in the memory (this limit value can be defined globally or likewise depend on further parameters, such as e.g. the movement or hoisting speed, temperature, load, an operating parameter of the crane or the like), the crane controller detects a deviation and carries out a characteristic map adaption (step S6).

By means of the characteristic map adaption, the current values for the actuation of the hoisting gear can be adapted to the deviations and thus, these deviations can be compensated, which result for example from component aging, a different component characteristic curve due to an exchange of components or from component tolerances. In other words, different current values are determined with reference to the adapted characteristic maps 10 to achieve the same setpoint speed.

In normal crane operation, the actual speed ideally is detected continuously (step S4) and compared with the setpoint specifications (step S5) so that deviations can be detected promptly and at any time. Moreover, larger data quantities thereby are available for a more robust characteristic map adaption (step S6).

Furthermore, special filters and/or algorithms can be provided, by means of which the measurement values or measurement cycles to be used or exploited for the comparison can be selected from the measured data. The actual and setpoint speeds can be maximum values. In addition, a fuzzy logic, RMS and/or other suitable methods can be used for the analysis of the deviations between actual and setpoint speeds. The characteristic map adaption (step S6) can be effected by means of a self-learning algorithm or by using machine-learning methods.

Due to the characteristic map adaption according to the disclosure, the quality of the (pilot) control is increased distinctly and systematic malfunctions and deviations are compensated by the superimposed regulation (adaption of the characteristic maps 10).

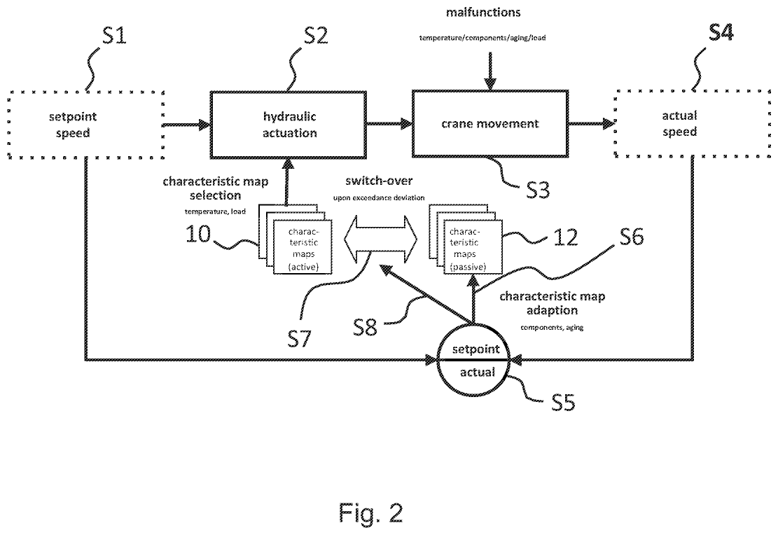

In the exemplary embodiment of FIG. 1, a direct feedback is effected, i.e. the characteristic maps 10 used for determining the current value (i.e. the control variable or regulating variable) are adjusted directly by the crane controller. An alternative exemplary embodiment is shown in FIG. 2. Here, the characteristic maps 10 currently used for determining the current values (also referred to as old, active or stationary characteristic maps or basic characteristic maps 10) are not adjusted, but upon detection of corresponding deviations between actual and setpoint speeds in step S5 new characteristic maps 12 (also referred to as new, inactive or passive characteristic maps 12) initially are generated and stored in the memory (or in a separate memory to which the crane controller has access) in parallel to the active characteristic maps 10 (step S6).

The characteristic map adaption continued in the further crane operation, is applied only to the inactive characteristic maps 12 so that the active characteristic maps 10 remain unchanged. A direct feedback thereby is avoided, which renders the system more robust. A change from the old characteristic maps 10 to the new optimized characteristic maps 12 in the determination of the current values (step S7) is effected at a fixed time, for example upon detection of a deviation between old and new characteristic maps 10, 12 or when a deviation between actual and setpoint speed lies above a defined limit value or threshold value (step S8). The change is effected in particular during a downtime of the crane so that the operator is not confronted with a sudden change in the control dynamics of the crane.

From the time of the change (step S7) the newly adjusted or optimized characteristic maps 12 are used for a determination of the current values or for actuation (step S2). The old characteristic maps 10 either are deleted or remain stored, for example as reference values which allow a future evaluation as regards the aging/wear of the components. Now, new characteristic maps 12 can again be generated in parallel and be adjusted by means of the continued measurement of the actual speed (step S4), until a new change in turn is effected (step S7).

In the exemplary embodiments described here, all steps are carried out locally in the implement. It is likewise conceivable, however, that one or more steps are outsourced to an external computer unit or cloud, for example the comparison between actual variable and setpoint variable, the selection of the measurement data used for this comparison, the evaluation of the deviations, the generation and possibly further adjustment of new characteristic curves and/or the decision as to when a change from the old to the new characteristic curves is effected.

### LIST OF REFERENCE NUMERALS

10 stored characteristic map
12 newly generated characteristic map
S1 specified setpoint speed
S2 actuation
S3 movement
S4 detection of actual speed
S5 comparison of actual and setpoint speed
S6 characteristic map adaption
S7 switch between old and new characteristic map
S8 initiation of the change

1. An implement comprising:
a drive by means of which a component can be moved,
a control unit by means of which the drive can be actuated,
a measuring device by means of which an actual variable relating to a movement of the actuated component can be detected, and
a memory in which at least one characteristic curve for the actuation of the drive is stored,
wherein the control unit is adapted
to determine a control variable for the actuation of the drive in dependence on a setpoint variable relating to the movement of the component with reference to a stored characteristic curve,
to compare the detected actual variable with the setpoint variable and to detect a deviation between the same and
to adjust the characteristic curve or to generate a new characteristic curve on the basis of the deviation and to store the same in the memory.

2. The implement according to claim 1, wherein the control unit is adapted to carry out the detection of the actual variable and the comparison with the setpoint variable several times during an operating period of the implement.

3. The implement according to claim 1, wherein in the memory a plurality of characteristic curves are stored, wherein the control unit is adapted to determine the control variable in dependence on the setpoint variable and at least one further variable with reference to the stored characteristic curve.

4. The implement according to claim 3, wherein the control unit is adapted to adjust a plurality of stored characteristic curves on the basis of the deviation between actual variable and setpoint variable and by taking account of the further variable, or to generate a plurality of new characteristic curves and store the same in the memory.

5. The implement according to claim 2, wherein the control unit is adapted to analyze a detected deviation between actual variable and setpoint variable and automatically carry out an adjustment of the stored characteristic curve or a generation and storage of a new characteristic curve.

6. The implement according to claim 2, wherein by means of the measuring device a plurality of measurement values of the actual variable can be detected at different times during the operating period of the implement, wherein the control unit is adapted to select one or more measurement values from the detected measurement values of the actual variable for the comparison with the setpoint variable.

7. The implement according to claim 1, wherein the control unit is adapted to generate a new characteristic curve and store it in the memory on the basis of a detected deviation between actual variable and setpoint variable and to furthermore determine the control variable with reference to an old characteristic curve.

8. The implement according to claim, 7, wherein the control unit is adapted to adjust the new characteristic curve upon detection of a further deviation between newly detected actual variable and setpoint variable and/or to generate another new characteristic curve and store it in the memory and to furthermore determine the control variable with reference to an old characteristic curve.

9. The implement according to claim 8, wherein the control unit is adapted to change the determination of the control variable with reference to an old characteristic curve to a determination of the control variable with reference to a newly generated characteristic curve, wherein the change is effected when a limit value for a deviation between actual variable and setpoint variable and/or between old and newly generated characteristic curve is exceeded, when a defined period of time expires and/or when a limit value for another detectable variable is exceeded or fallen short of.

10. The implement according to claim 9, wherein the control unit is adapted to carry out the change from the old to the new characteristic curve automatically.

11. The implement according to claim 1, wherein in a calibration mode the control unit is adapted to generate at least one new characteristic curve and store it in the memory by the targeted actuation of the drive and the sequential detection of a plurality of values of the actual variable during the movement of the component, wherein the calibration mode can be activated manually and/or automatically.

12. The implement according to claim 1, wherein the control unit is adapted to take account of operating information stored in the memory when the deviation between actual variable and setpoint variable is detected and/or when the detected deviation is analyzed, which operating information relates to an exchange, a repair, a period of use or a wear of at least one component of the implement.

13. The implement according to claim 1, wherein the drive is a hydraulic drive which can be pilot-controlled via a hydraulic actuator.

14. A method of actuating the drive of the implement according to claim 5, comprising the following steps:
determining the control variable in dependence on the setpoint variable with reference to the stored characteristic curve by means of the control unit,
actuating the drive by means of the control unit on the basis of the control variable, in order to move the component,
detecting the actual variable by means of the measuring device,
comparing actual variable and setpoint variable by means of the control unit,
detecting the deviation between actual variable and setpoint variable by means of the control unit, and
adjusting the stored characteristic curve or generating and storing the new characteristic curve on the basis of the detected deviation by means of the control unit.

15. The method according to claim 14, wherein the actual variable is detected several times in a row during the operating period of the implement and is compared with the setpoint variable, wherein during operation the old stored characteristic curve is adjusted and/or the new characteristic curve is generated and the same is adjusted dynamically, wherein the control variable furthermore is determined with reference to an old stored characteristic curve until the limit value for the deviation between actual variable and setpoint variable and/or between the old stored characteristic curve and the newly generated characteristic curve is exceeded, until a defined time period expires and/or until a limit value for another detectable variable is exceeded or fallen short of, whereupon the control variable is determined from this time with reference to the newly generated characteristic curve.

16. The implement according to claim 1, wherein the implement is a crane or excavator.

17. The implement according to claim 2, wherein the control unit is adapted to carry out the detection of the actual variable and the comparison with the setpoint variable at regular time intervals.

18. The implement according to claim 3, wherein the further variable can be detected by means of a further measuring device and relates to an operating parameter of the implement, a temperature and/or a load.

19. The implement according to claim 10, wherein the control unit is adapted to carry out the change outside the operation of the implement.

20. The implement according to claim 13, wherein the control variable relates to a current value for the actuation of the drive or actuator and/or the setpoint variable relates to a speed.
